(19) United States
(12) Patent Application Publication
(10) Pub. No.: US 2025/0291899 A1
(43) Pub. Date: Sep. 18, 2025

(54) DIFFUSION-BASED AUDIO PURIFICATION FOR DEFENDING AGAINST ADVERSARIAL DEEPFAKE ATTACKS

(71) Applicant: Pindrop Security, Inc., Atlanta, GA (US)

(72) Inventors: Andre KASSIS, Atlanta, GA (US); Tianxiang CHEN, Atlanta, GA (US); Elie KHOURY, Atlanta, GA (US)

(73) Assignee: Pindrop Security, Inc., Atlanta, GA (US)

(21) Appl. No.: 19/076,895

(22) Filed: Mar. 11, 2025

Related U.S. Application Data
(60) Provisional application No. 63/564,449, filed on Mar. 12, 2024.

(51) Int. Cl. G06F 21/55; G10L 17/06; G10L 17/18

(52) U.S. Cl. CPC G06F 21/55; G10L 17/06; G10L 17/18

(57) ABSTRACT

Disclosed are systems and methods including software processes executed by a server that detect audio-based synthetic speech (“deepfakes”). Embodiments implement a machine-learning architecture having a diffusion model that generates purified features that are fed to a deepfake detection model. The machine-learning architecture includes input layers that convert an audio signal into a Gaussian or frequency space representation (e.g., log spectrogram) to extract a set of initial features indicative of spoofing or deepfake attacks. The diffusion model identifies adversarial noise on the audio signal in the initial features and generates purified features or clean version of the input audio signal. A deepfake detector includes a neural network architecture and classifier programmed and trained to generate a deepfake detection score and classify the audio signal as genuine or fraudulent using the purified features.

### CROSS-REFERENCE TO RELATED APPLICATIONS

This application claims the benefit of priority to U.S. Provisional Application No. 63/564,449, filed Mar. 12, 2024, which is incorporated by reference in its entirety.

### TECHNICAL FIELD

This application generally relates to systems and methods for managing, training, and deploying a machine learning architecture for call data processing. In particular, this application relates to using machine-learning techniques for mitigating deepfakes in fraudulent audio data.

### BACKGROUND

Automatic speaker verification (ASV) systems are often essential software programs for call centers. For instance, an ASV allows the callers or end-users (e.g., customers) to authenticate themselves to the call center based on the caller's voice during the phone call with a call center agent, or the ASV may capture spoken inputs to an interactive voice response (IVR) program of the call center. The ASV significantly reduces the time and effort of performing functions at the call center, such as authentication. These ASV systems have significantly improved due to deep learning algorithms. However, ASVs are vulnerable to malicious attacks, such as deepfake attacks, often resulting from improved deep learning technologies. In deepfake fake attaches, a malicious actor employs software that outputs machine-generated speech (sometimes referred to as deepfake speech or machine-generated speech) using Text-To-Speech (TTS) or generative-AI software for performing speech synthesis or voice-cloning of any person's voice. The promulgation of sophisticated, deep-learning-based software, such as TTS and voice conversion (VC) techniques, has made it difficult to distinguish between genuine and spoofed audio and speech.

Anti-spoofing or deepfake technologies benefit from more sophisticated approaches to machine-learning models, but these conventional technologies can be fooled by injecting certain noise or disruptions in the audio signal data. Recent studies have shown that even minor perturbations being added to signal data of audio deepfake samples could be sufficient to evade state-of-the-art anti-spoofing systems. What is needed is anti-fraud solution that the can detect and mitigate against such adversarial deepfake attacks.

### SUMMARY

Disclosed herein are systems and methods capable of addressing the above-described shortcomings and may also provide any number of additional or alternative benefits and advantages. Embodiments include systems and methods for detecting deepfake audio signals. A computing device implements a machine-learning model of a machine-learning architecture for deepfake detection. The machine-learning architecture includes a diffusion-based purification pipeline as a preprocessing layer. This diffusion model identifies adversarial noise or other adversarial artifacts in low-level features extracted from audio signals, and then generates purified features and/or a reconstructed, clean version of the input audio signal. A deepfake detection model (e.g., CNN or ResNet-based spoof or deepfake detection model) is trained to produce a final spoofing score using the purified features.

Embodiments may include a computer-implemented method for detecting fraudulent calls based on adversarial noise indicating adversarial attacks. The method may include: extracting, by a computer, a plurality of input features for an input audio signal; identifying, by the computer, an instance of adversarial noise in the input audio signal based upon the plurality of input features using a diffusion model of a machine-learning architecture, the diffusion model trained to identify instances of adversarial noise features extracted in audio signals; generating, by the computer, a plurality of purified features corresponding to the plurality of input features according to the instance of the adversarial noise as identified in the input audio signal using the diffusion model; generating, by the computer, a deepfake score for the input audio signal indicating a likelihood that the input audio signal is fraudulent using a deepfake detector of the machine-learning architecture based upon the plurality of purified features; and identifying, by the computer, the input audio signal as genuine or fraudulent based upon the deepfake score.

The method may further include generating, by the computer, a loss for the diffusion model using a loss function, the loss indicating a distance between the plurality of purified features for the input audio signal and a plurality of expected purified features indicated by a training label associated with the input audio signal; and updating, by the computer, one or more diffusion parameters of the diffusion model based upon the loss.

The method may further include generating, by the computer, a loss for the deepfake detector using a loss function, the loss indicating a distance between the deepfake score as generated for the input audio signal and an expected deepfake score indicated by a training label associated with the input audio signal; and updating, by the computer, one or more diffusion parameters of the diffusion model based upon the loss; and updating, by the computer, one or more detection parameters of the deepfake detector based upon the loss.

The method may further include receiving, by the computer, the input audio signal having the plurality of features; and executing, by the computer, a transformation function on the input audio signal to convert the input audio signal from a time domain to a transformed domain. The computer extracts the plurality of features from the transformed domain of the input audio signal. The transformed domain may include at least one of a Gaussian space, a frequency domain, or a time-frequency domain.

The method may further include generating, by the computer, a clean version of the input audio signal based upon the plurality of purified features using a transform function.

The method may further include extracting, by the computer, a fakeprint feature vector embedding based upon the plurality of purified features. The deepfake detector may generate the deepfake score using the fakeprint feature vector embedding.

The computer may identify the input audio signal fraudulent in response to determining that the deepfake scores satisfies a fraud detection threshold score. The method may further include generating, by the computer, an alert notification for display at a user interface indicating that the input audio signal has been identified as fraudulent in response to determining that the deepfake score satisfied the fraud detection threshold score.

Embodiments may include a system for detecting fraudulent calls based on adversarial noise indicating adversarial attacks. The system may including a computer having at least one processor, where the computer is configured to: extract a plurality of input features for an input audio signal; identify an instance of adversarial noise in the input audio signal based upon the plurality of input features using a diffusion model of a machine-learning architecture, the diffusion model trained to identify instances of adversarial noise features extracted in audio signals; generate a plurality of purified features corresponding to the plurality of input features according to the instance of the adversarial noise as identified in the input audio signal using the diffusion model; generate a deepfake score for the input audio signal indicating a likelihood that the input audio signal is fraudulent using a deepfake detector of the machine-learning architecture based upon the plurality of purified features; and identify the input audio signal as genuine or fraudulent based upon the deepfake score.

The computer may be further configured to generate a loss for the diffusion model using a loss function, the loss indicating a distance between the plurality of purified features for the input audio signal and a plurality of expected purified features indicated by a training label associated with the input audio signal; and update one or more diffusion parameters of the diffusion model based upon the loss.

The computer may be further configured to generate a loss for the deepfake detector using a loss function, the loss indicating a distance between the deepfake score as generated for the input audio signal and an expected deepfake score indicated by a training label associated with the input audio signal; and update one or more diffusion parameters of the diffusion model based upon the loss; and update one or more detection parameters of the deepfake detector based upon the loss.

The computer may be further configured to receive the input audio signal having the plurality of features; and execute a transformation function on the input audio signal to convert the input audio signal from a time domain to a transformed domain. The computer may extract the plurality of features from the transformed domain of the input audio signal. The transformed domain may include at least one of a Gaussian space, a frequency domain, or a time-frequency domain.

The computer may be further configured to generate a clean version of the input audio signal based upon the plurality of purified features using a transform function.

The computer may be further configured to extract a fakeprint feature vector embedding based upon the plurality of purified features. The deepfake detector may generate the deepfake score using the fakeprint feature vector embedding.

The computer may identify the input audio signal fraudulent in response to determining that the deepfake scores satisfies a fraud detection threshold score. The computer may be further configured to generate an alert notification for display at a user interface indicating that the input audio signal has been identified as fraudulent in response to determining that the deepfake score satisfied the fraud detection threshold score.

Embodiments may include a non-transitory computer readable medium configured to store executable instructions for detecting fraudulent calls based on adversarial noise indicating adversarial attacks. When executed by one or more processors, the instructions may instruct the one or more processor to: extract a plurality of input features for an input audio signal; identify an instance of adversarial noise in the input audio signal based upon the plurality of input features using a diffusion model of a machine-learning architecture, the diffusion model trained to identify instances of adversarial noise features extracted in audio signals; generate a plurality of purified features corresponding to the plurality of input features according to the instance of the adversarial noise as identified in the input audio signal using the diffusion model; generate a deepfake score for the input audio signal indicating a likelihood that the input audio signal is fraudulent using a deepfake detector of the machine-learning architecture based upon the plurality of purified features; and identify the input audio signal as genuine or fraudulent based upon the deepfake score.

The instructions may further instruct the one or more processors to: generate a loss for the deepfake detector using a loss function, the loss indicating a distance between the deepfake score as generated for the input audio signal and an expected deepfake score indicated by a training label associated with the input audio signal; and update one or more diffusion parameters of the diffusion model based upon the loss; and update one or more detection parameters of the deepfake detector based upon the loss.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of an example system for handling and analyzing calls from callers, according to embodiments.

FIG. 2 shows dataflow amongst components of a system for deepfake detection in caller audio data using a machine-learning architecture, according to embodiments.

FIG. 3 is a flowchart showing operations of a process for detecting adversarial deepfake attacks audio signal data using a machine-learning architecture, according to embodiments.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Conventional deepfake detection methods are often ineffective against certain types of adversarial attacks. These attacks can be categorized into white box (where the attacker has access to a detection models architecture and parameters) and black box (where the attacker learns patterns of behavior from the input and output without access to the detection model). Adversarial attacks often involve adding noise to the original signal to fool the detection model. But conventional detection methods lack robust mechanisms to effectively identify and remove this noise for the purposes of detecting fraudulent audio signals.

Conventional detection models often fail to adequately generalize against various types of adversarial noise attacks. While the conventional approaches may perform adequately against certain signal processing-based attacks, the conventional approaches struggle with more sophisticated adversarial techniques. Moreover, some conventional detection methods rely heavily on certain types of specific low-level acoustic features, such as MFCCs or LFCCs, for detecting spoofing or deepfakes. While the detection models may rely on these types of features for identifying certain types of spoofing or deepfake detection, these types of features are usually insufficient for detecting and countering instances of adversarial noise injected into the audio signal.

Embodiments described herein implement a machine-learning architecture having a diffusion-based model that generates purified features that are fed to a deepfake detection model. The diffusion-based model is designed to identify and remove adversarial noise from features of an input audio signal, effectively reconstructing a clean version of the input audio signal. The machine-learning architecture includes input layers that converting an audio signal into a frequency space representation (e.g., log spectrogram) to extract a set of initial features indicative of spoofing or deepfake attacks. The machine-learning architecture then applies the diffusion model to denoise the initial features and generate the purified features or clean version of the input audio signal. The machine-learning architecture feeds the purified features to a machine-learning model of deepfake detector that includes a neural network architecture and classifier programmed and trained to generate a deepfake detection score and classify the audio signal as genuine or fraudulent.

By generating denoised purified features and/or clean versions of an input audio signal, this diffusion-model approach improves the accuracy of deepfake detection models and allows deepfake detection machine-learning architectures to better generalize for detecting previously unseen and new adversarial attacks. Prior denoising approaches generally intended to improve the audio quality of audio signals for human perception or intelligibility by models. These prior denoising approaches focused on reducing background noise and enhancing the clarity of the audio signal, often measured by subjective metrics like Mean Opinion Score (MOS). Prior denoising approaches typically use techniques like spectral subtraction, Wiener filtering, or deep learning models trained to minimize noise in the time-frequency domain. These prior approaches may not specifically target adversarial noise and, in the effort of improving audio quality, can sometimes alter the audio signal in ways that affect the performance of deepfake detection.

The diffusion model of the embodiments described herein specifically targets adversarial noise introduced by attackers to fool detection models. The diffusion model generates the purified features by removing adversarial noise or other adversarial artifacts distorting the audio signal, such that the deepfake detector can accurately classify the audio. The focus is on enhancing the robustness of the deepfake detection against adversarial attacks. The diffusion-model approach employs a diffusion model that transforms input features into a Gaussian space, removes the adversarial noise, and generates purified features. The diffusion model may also transform the purified features to an original time domain to reconstruct a clean purified version of the input signal, without the adversarial noise or other adversarial artifacts on the input audio signal.

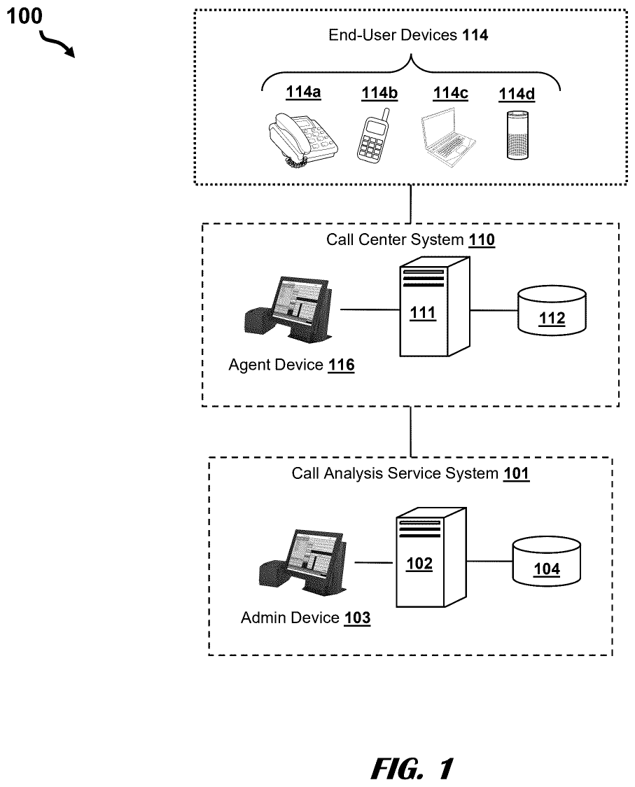

FIG. 1 shows components of an example system 100 for handling and analyzing calls from callers, according to an embodiment. The system 100 includes components that, for example, recognize and authenticate callers, and evaluate fraud risks for calls. Evaluating or detecting fraud risks may include operations for identifying instances of fraudulent audio signals, such as deepfake or synthetic audio signals, received during a conversation over a telephone call or any app-based call having audio features (e.g., WhatsApp® call, Skype® call). The system 100 comprises a call analytics system 101, call center systems 110 of customer enterprises (e.g., companies, government entities, universities), and caller devices 114a-114d (generally referred to as end-user devices 114 or an end-user device 114). The call analytics system 101 includes analytics servers 102, analytics databases 104, and admin devices 103. The call center system 110 includes call center servers 111, call center databases 112, and agent devices 116.

Embodiments may comprise additional or alternative components or omit certain components from those of FIG. 1, and still fall within the scope of this disclosure. It may be common, for example, to include multiple call center systems 110 or for the call analytics system 101 to have multiple analytics servers 102. Embodiments may include or otherwise implement any number of devices capable of performing the various features and tasks described herein. For example, the FIG. 1 shows the analytics server 102 as a distinct computing device from the analytics database 104. In some embodiments, the analytics database 104 may be integrated into the analytics server 102.

Various hardware and software components of one or more public or private networks may interconnect the various components of the system 100. Non-limiting examples of such networks may include Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols. Likewise, the caller devices 114 may communicate with callees (e.g., call center systems 110) via telephony and telecommunications protocols, hardware, and software capable of hosting, transporting, and exchanging audio data associated with telephone calls. Non-limiting examples of telecommunications hardware may include switches and trunks, among other additional or alternative hardware used for hosting, routing, or managing telephone calls, circuits, and signaling. Non-limiting examples of software and protocols for telecommunications may include SS7, SIGTRAN, SCTP, ISDN, and DNIS among other additional or alternative software and protocols used for hosting, routing, or managing telephone calls, circuits, and signaling. Components for telecommunications may be organized into or managed by various different entities, such as carriers, exchanges, and networks, among others.

The description of FIG. 1 mentions circumstances in which a calling end-user (caller) places a current or inbound call through various communications channels to contact and interact with the services offered by the call center system 110, though the operations and features of the speaker verification and fraud-risk detection techniques described herein may be applicable to any circumstances involving a voice-based interface between the caller and the services offered by the call center system 110. The call may be placed using various types of telephony communications, implementing the hardware, software, and protocols corresponding to the type of communications channel. For instance, the operations described herein could be implemented by any call center system 110 that receives speaker audio inputs via one or more types of communications channels. The end-users can, for example, access user accounts, services, or features of the service provider and service provider's call center system 110, which may include interacting with human agents or with software applications (e.g., cloud application, website-based application with voice interface) hosted by call center servers 111.

In some implementations, the users of the service provider's call center system 110 may access the user accounts or other features of the service provider by placing calls using the various types of end-user devices 114. The callers may also access the user accounts or other features of the service provider using software executed by certain end-user devices 114 configured to exchange data and instructions with software programming (e.g., the cloud application) hosted by the call center servers 111. The customer call center system 110 may include, for example, human agents who converse with callers during telephone calls, Interactive Voice Response (IVR) software executed by the call center server 111, or the cloud software programming executed by the call center server 111. The customer call center 110 need not include any human agents, such that the end-user interacts only with the IVR system or the cloud software application.

The end-user devices 114 may be any communications or computing device that the caller operates to access the services of the call center system 110 through the various types of communications channels. The end-user devices 114 comprise or connect with a microphone device for capturing audio waveforms and converting the audio waveforms to electrical audio signals. The caller may place the call to the call center system 110 through a telephony network or through a software application executed by the caller device 114. A device of the call center system 110, such as a provider server 111, captures and forwards the input audio signal data to the analytics system 101 to perform the various processes described herein. Non-limiting examples of caller devices 114 may include landline phones 114a, mobile phones 114b, calling computing devices 114c, edge devices 104d, or other types of electronic devices capable of voice communications. The landline phones 114a and mobile phones 114b are telecommunications-oriented devices (e.g., telephones) that communicate via telecommunications channels. The end-user device 114 is not limited to the telecommunications-oriented devices or channels. For instance, in some cases, the mobile phones 114b may communicate via a computing network channel (e.g., the Internet). The caller device 114 may also include an electronic device comprising a processor and/or software, such as a caller computing device 114c or edge device implementing, for example, voice-over-IP (VOIP) telecommunications, data-streaming via a TCP/IP network, or other computing network channel. The edge device 114d may include any Internet of Things (IoT) device or other electronic device for network communications. The edge device 114d could be any smart device capable of executing software applications and/or performing voice interface operations. Non-limiting examples of the edge device 114d may include voice assistant devices, automobiles, smart appliances, and the like.

The call analytics system 101 and the call center system 110 represent network infrastructures 101, 110 comprising physically and logically related software and electronic devices managed or operated by various enterprise organizations. The devices of each network system infrastructure 101, 110 are configured to provide the intended services of the particular enterprise organization.

The analytics server 102 of the call analytics system 101 may be any computing device comprising hardware (e.g., at least one processor, non-transitory machine-readable media) and software (e.g., executable machine-readable instructions stored in non-transitory media), and capable of performing the various processes and tasks described herein. The analytics server 102 may host or be in communication with the analytics database 104, and receives and processes call data (e.g., audio recordings, metadata) received from the one or more call center systems 110. Although FIG. 1 shows only single analytics server 102, the analytics server 102 may include any number of computing devices. In some cases, the computing devices of the analytics server 102 may perform all or sub-parts of the processes and benefits of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the call center system 110 (e.g., the call center server 111).

The analytics server 102 executes audio-processing software that includes one or more machine-learning architectures having functions, layers, and other aspects of a machine-learning architecture (e.g., machine-learning models) to perform various types of operations for speaker recognition, verification and authentication, and fraud detection (e.g., deepfake or liveness detection; spoof detection). For ease of description, the analytics server 102 is described as executing a single machine-learning architecture, though multiple machine-learning architecture architectures could be employed in some embodiments.

The machine-learning architecture operates logically in several operational phases, including a training phase and a deployment phase (sometimes referred to as a “test” phase, “testing,” or “inference time”). The inputted audio signals processed by the analytics server 102 and the machine-learning architecture include training audio signals processed during the training phase and inbound audio signals processed during the deployment phase. The analytics server 102 applies the machine-learning architecture to each type of inputted audio signal during the corresponding operational phase.

The machine-learning architecture includes the input layers for extracting input features from an input audio signal and performing additional preprocessing or data augmentation operation, a purification engine for generating purified features using the input features, and a deepfake detector for determining whether the input audio signal is genuine or fraudulent (e.g., likely contains deepfake audio data) using the purified features of the input audio signal.

The analytics server 102 or other computing device of the system 100 (e.g., call center server 111) can perform various pre-processing operations and/or data augmentation operations on the input audio signals. Non-limiting examples of the pre-processing operations on inputted audio signals may include parsing and segmenting the audio signal into frames or segments, performing one or more transformation functions (e.g., FFT, SFT), extracting features or feature vectors, and extracting purified features or purified feature vectors, among other potential pre-processing operations. Non-limiting examples of data augmentation operations include audio clipping, background or resonance noise augmentation, adversarial noise augmentation, frequency augmentation, and duration augmentation, among other potential data augmentation operations. In some cases, the analytics server 102 may executes certain pre-processing or data augmentation operations as operations of input layers of the machine-learning architecture. Additionally or alternatively, in some cases, the analytics server 102 may perform certain pre-processing or data augmentation operations prior to feeding the input audio signals into the input layers of the machine-learning architecture.

The input layers may include programming for extracting low-level input features from the input audio signal. For instance, the input layers convert the input audio signal into a Gaussian or frequency space representation, such as a log spectrogram or linear filter banks (LFBs), using one or more transformation functions. This representation captures the frequency content of the audio signal over time, providing a detailed view of the signal characteristics. The log spectrogram is used by the input layers for extracting the input features. The input features extracted from the log spectrum by the input layers may be useful for identifying and removing adversarial noise in the input audio signal.

The purification engine includes a diffusion-based machine-learning model that denoises the input audio signal by removing the adversarial noise from the input audio features. The diffusion model ingests the input features and generates the purified features for the input signal. The diffusion model of the purification engine is programmed and trained to identify the instances of adversarial noise in the Gaussian or other transform domain of the input features.

The diffusion model is further programmed and trained to remove the identified adversarial noise within the input signal represented in the input features and generate corresponding purified features of a clean signal without the adversarial noise. The purification engine outputs the purified features that have been denoised or otherwise free from adversarial artifacts. In some implementations, the purification engine or other component of the machine-learning architecture may execute a transform function on the purified features to reconstruct or otherwise generate the clean version of the input audio signal.

For example, the diffusion model first transforms the input audio signal, which includes adversarial noise, into a Gaussian space. This transformation helps in isolating the noise components from the original input audio signal. In the Gaussian space, the diffusion model identifies and removes the adversarial noise. This is achieved by leveraging the properties of the Gaussian distribution to distinguish between the genuine signal and the added noise. After removing the noise, the model diffusion generates purified features and, in some cases, reconstructs the purified audio signal from the Gaussian space back to an original time domain. This reconstructed signal is now free from adversarial noise and can be used for accurate deepfake detection.

The deepfake detector of the machine-learning architecture includes layers of one or more machine-learning models programmed and trained for determining whether an input audio signal is genuine or fraudulent, or otherwise detecting instances of fraud (e.g., deepfakes, spoofing) in the input audio signal. Layers of a neural network within the deepfake detector are trained to operate as embedding extractors that generate feature vectors representing certain types of embeddings using features indicative of fraudulent audio signals (sometimes referred to as “fakeprints” or “spoofprints”). As an example, the fakeprint embedding extractor may be a neural network architecture (e.g., ResNet, SyncNet) that processes a first set of features extracted from the input audio signals, where the fakeprint extractor comprises any number of convolutional layers, statistics layers, and fully-connected layers and trained according to one or more types of loss functions. In some cases, the deepfake detector generates the fakeprint using the purified features received from the diffusion model. In some cases, the deepfake detector receives the clean version of the input audio signal, extracts the purified features of interest to the deepfake detector, and extracts the fakeprint using the purified features.

Scoring layers and/or classifier layers of the deepfake detector are programmed and trained to generate a deepfake score and fraud determination using the fakeprint based on similarities between the fakeprint and previously trained or generated fraud-detection clusters. The machine-learning architecture feeds the fakeprint to the fraud classifier or scoring layers to perform various scoring operations. The scoring layers and/or the fraud classifier perform a distance scoring operation that determines the distance (e.g., similarities, differences) between the fakeprint and a centroid or feature vector previously generated as fraud-detection cluster using training fakeprints extracted for the training audio signals. The deepfake score indicates the likelihood that the input audio signal is genuine or fraudulent. The deepfake score may be a value generated by the scoring layers and/or fraud classifier based on one or more scoring operations (e.g., distance scoring). For instance, the scoring layers or other component of the deepfake detector determines whether the distance score or other outputted values satisfy threshold values.

Example embodiments of the deepfake detection engine may be found in U.S. application Ser. No. 18/646,228, U.S. Pat. No. 11,862,177, each of which is incorporated by reference in its entirety.

During the training phase, the analytics server 102 receives training audio signals of various acoustic and signal characteristics from one or more corpora, which may be stored in an analytics database 104, a call center database 112, or other non-transitory storage medium. The training audio signals include genuine audio signals (sometimes referred to as samples) both genuine and fraudulent audio signals. Genuine audio samples contain clear and identifiable speech, without adversarial noise and are verified to originate from trusted sources. These clean audio samples help a diffusion model and deepfake detector learn characteristics of unaltered audio and establish an accurate baseline for the denoising process. Fraudulent audio samples, or adversarially modified audio signals, contain features designed to simulate signal degradation or distortion.

At the deployment phase, the analytics server 102 receives an inbound audio signal that originated from an end-user device 114 and executes the machine-learning architecture on the inbound audio signals. The analytics server 102 feeds the inbound audio signal to the input layers of the machine-learning architecture to perform various preprocessing operations on the inbound audio signal, which includes extracting inbound input features of the inbound audio signal. The machine-learning architecture feeds the inbound audio features to a purification engine of the machine-learning architecture having the diffusion model. The diffusion model identifies instances of adversarial noise occurring in the inbound input features and generates inbound purified features corresponding to the inbound input features. In some cases, the diffusion model or other component of the machine-learning architecture generates a clean version of the inbound audio signal using the inbound purified features.

The deepfake detector or other component of the machine-learning architecture may extract an inbound fakeprint using the inbound purified features or the clean version of the inbound audio signal. The scoring layers of the deepfake detector generate an inbound deepfake score based on the inbound fakeprint, where the inbound deepfake score indicates a likelihood that the inbound audio signal is genuine or fraudulent. Based on the inbound deepfake score, classifier layers of the deepfake detector can determine whether the input audio signal is genuine or fraudulent. For instance, the deepfake detector may determine that the inbound audio signal is a fraudulent signal containing an adversarial deepfake signal noise in response to determining that the inbound deepfake score satisfies a fraud detection threshold.

The analytics server 102 may generate a notification or other outputs for display at a user interface of a client device (e.g., agent devices 116, admin devices 103, end-user devices 114) indicating the results of the machine-learning architecture.

The analytics database 104 and/or the call center database 112 may contain any number of corpora of training audio signals that are accessible to the analytics server 102 via one or more networks. In some embodiments, the analytics server 102 employs supervised training to train the machine-learning models of the machine-learning architecture, where the analytics database 104 includes labels associated with the training audio signals that indicate, for example, the characteristics or features of the training audio signals. An administrator may configure the analytics server 102 to select the training audio signals having certain characteristics or features.

The call center server 111 of a call center system 110 executes software processes for managing a call queue and/or routing calls made to the call center system 110 through the various channels, where the processes may include, for example, routing calls to the appropriate call center agent devices 116 based on the inbound caller's comments, instructions, IVR inputs, or other inputs submitted during the inbound call. The call center server 111 can capture, query, or generate various types of information about the call, the caller, and/or the caller device 114 and forward the information to the agent device 116, where a graphical user interface (GUI) of the agent device 116 displays the information to the call center agent. The call center server 111 also transmits the information about the inbound call to the call analytics system 101 to preform various analytics processes on the inbound audio signal and any other audio data. The call center server 111 may transmit the information and the audio data based upon preconfigured triggering conditions (e.g., receiving the inbound phone call), instructions or queries received from another device of the system 100 (e.g., agent device 116, admin device 103, analytics server 102), or as part of a batch transmitted at a regular interval or predetermined time.

The admin device 103 of the call analytics system 101 is a computing device allowing personnel of the call analytics system 101 to perform various administrative tasks or user-prompted analytics operations. The admin device 103 may be any computing device comprising a processor and software, and capable of performing the various tasks and processes described herein. Non-limiting examples of the admin device 103 may include a server, personal computer, laptop computer, tablet computer, or the like. In operation, the user employs the admin device 103 to configure the operations of the various components of the call analytics system 101 or call center system 110 and to issue queries and instructions to such components.

The agent device 116 of the call center system 110 may allow agents or other users of the call center system 110 to configure operations of devices of the call center system 110. For calls made to the call center system 110, the agent device 116 receives and displays some or all of the relevant information associated with the call routed from the call center server 111. The agent device 116 includes a user interface that presents the information determined by the analytics server 102 about the caller or end-user device, including one or more scores or determinations, such as a message or alert notification indicating the call is likely fraud. The admin device allows the call center to agent to manage the agent's ongoing call status or queue, which includes allowing the agent to reject calls or route calls or otherwise perform mitigation actions when the analytics server 102 determines and indicates that the call is likely fraud.

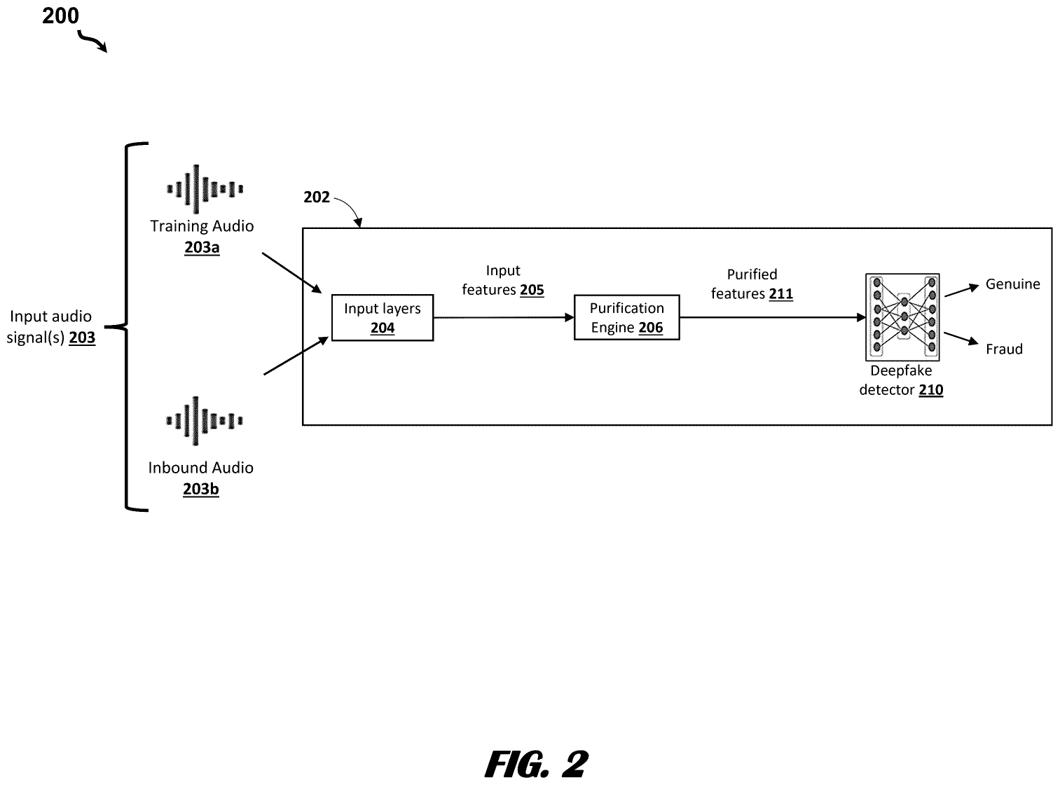

FIG. 2 shows dataflow amongst components of a system 200 for deepfake detection in caller audio data using a machine-learning architecture 202, according to an embodiment. The system 200 includes a server (e.g., analytics server 102) executing software programming and routines that implement a machine-learning architecture for deepfake detection. In the example system 200, the server executes the software programming of machine-learning layers of machine-learning models within the machine-learning architecture 202 for detecting deepfakes in input audio signals 203a-203b (generally referred to as input audio signals 203 or an input audio signal 203) at various operational phases (e.g., training, deployment). For instance, at a training phase, the server executes the machine-learning architecture 202 using training audio signals 203a. At a deployment phase, the server executes the machine-learning architecture 202 using inbound audio signals 203b.

The server includes and executes software programming of the various layers and functions of the machine-learning architecture 202 for processing one or more input audio signals 203 and detecting deepfakes that may occur in an input audio signal 203. The machine-learning architecture 202 includes input layers 204 for extracting input features 205 from an input audio signal 203, a purification engine 206 for generating purified features 211 using the input features 205, and a deepfake detector 210 for determining whether the input audio signal 203 is genuine or fraudulent (e.g., likely contains deepfake audio data) using the purified features 211 of the input audio signal 203.

The training audio signals 203a used for training the components of the machine-learning architecture 202 for detecting adversarial deepfake attacks include a diverse set of audio samples with varying acoustic characteristics having features indicative of whether a training audio signal 203a includes fraud, such as adversarial noise. The training audio signals 203a may include bona fide or genuine audio samples and fraudulent audio samples.

The genuine audio samples are clean audio signals 203 containing clear and identifiable speech audio, which may be verified or known to be originated from a trusted or verified source. The genuine samples include voiced-speech portions, where a speaker is clearly speaking, and unvoiced-speech portions, where the audio might contain background noise or silence without any speech. The clean audio samples help a diffusion model of a purification engine 206 and a deepfake detector 210 to learn the characteristics of original, unaltered audio signals 203 and for constructing an accurate baseline during the denoising process of the diffusion model of the purification engine 206.

The fraudulent audio samples or adversarially modified audio samples are input audio signals 203 containing signal features designed to simulate various types of signal degradation or distortion that might be introduced by malicious actors. These samples include adversarial artifacts intended to deceive the deepfake detector 210. Examples of adversarial modifications might include adversarial noise, audio clipping, frequency manipulation, and duration manipulation, among others. In adversarial noise, signal noise is added intentionally to obscure the genuine signal or to mimic characteristics of a different speaker. In audio clipping, the input audio signal 203 is truncated or cut at parts to create gaps or overlaps that complicate the detection process. In frequency manipulation, the frequency content of the audio signal 203 is altered in order to distort the voice characteristics such that voice features resemble those of another individual. In duration augmentation, the timing or duration of speech segments of the audio signal 203 is altered in order to disrupt the natural flow of speech, making it harder to match with genuine patterns.

The input layers 204 of the machine-learning architecture 202 include executable operations for ingesting input audio signals 203 and performing various pre-processing and augmentation operations. Non-limiting examples of the pre-processing operations include extracting low-level input features 205 from an input audio signal 203, parsing and segmenting the input audio signal 203 into frames and segments and performing one or more transformation functions, such as Short-time Fourier Transform (SFT) or Fast Fourier Transform (FFT), among other potential pre-processing operations. Non-limiting examples of augmentation operations include audio clipping, noise augmentation, frequency augmentation, duration augmentation, and the like.

In some implementations, input layers 204 extract low-level input features 205 from the input audio signal 203. For instance, the input layers 204 converts the input audio signal 203 into a Gaussian or frequency space representation, such as a log spectrogram or linear filter banks (LFBs), using one or more transformation functions. This representation captures the frequency content of the audio signal 203 over time, providing a detailed view of the signal characteristics. The log spectrogram is used by the input layers 204 for extracting the input features 205. The input features 205 extracted from the log spectrum by the input layers 204 may be useful for identifying and removing adversarial noise in the input audio signal 203. In some cases, the LFB features are derived from the audio signal 203 and provide a different perspective on the frequency content, which can be beneficial for the diffusion model's denoising process.

The input layers 204 extract and output the low-level input features 205 of the input audio signal 203. The machine-learning architecture 202 then feeds the input features 205 to the purification engine 206.

The purification engine 206 includes a diffusion model layer that ingests the input features 205 from the feature extraction operations of the input layers 204 and generate the purified features 211 based on the input features 205. The diffusion model of the purification engine 206 executes a diffusion-based machine-learning model for denoising the input features 205. The diffusion model is trained to identify and remove adversarial noise, reconstructing the original clean signal. The purification engine 206 outputs the purified features 211 that have been denoised and are free from adversarial artifacts. The diffusion model within the purification engine 206 is a machine-learning model designed to identify and remove adversarial noise from input audio signals 206. The diffusion model operates by reconstructing an original clean signal through a series of denoising processes executed on the input features 205, ultimately generating purified features 211 from the input features 205.

The diffusion model starts by ingesting the input features 205 derived from the input audio signal 203. These input features 205 are typically extracted by the input layers 204 using transformation functions (e.g., SFT, FFT). The diffusion model then performs a denoising process. The diffusion model is trained to identify adversarial noise of the audio signal 203. For instance, the adversarial noise may be introduced into an input audio signal 203 as adversarial artifacts by the operations for generating or presenting fraudulent audio signaling data intended to bypass fraud detection operations. The diffusion model identifies and separates the adversarial noise from genuine signal components of the input audio signal 203. This involves reconstructing an original clean signal (of the input audio signal 203) by progressively refining the input features 205 through iterative denoising operations. The output of the diffusion model is the purified features 211, which are free from adversarial artifacts. These purified features 211 retain the essential characteristics of the original audio signal (of the input audio signal 203).

Examples of specific operations performed by the diffusion model include adversarial noise identification, signal reconstruction, and purification pipeline. In adversarial noise identification, the diffusion model uses statistical and machine-learning techniques to detect patterns in the input features 205 that are indicative of adversarial noise. In signal reconstruction, the diffusion model reconstructs the clean audio signal by removing identified noise components and retaining the genuine signal features. This is done through iterative refinement, where the signal is gradually purified over multiple passes. The purification engine 206 may include a purification pipeline layer for additional processing for generating the purified features 211. The purification pipeline layer ingests the purified features 211 from the diffusion model and executes additional processing operations to refine the purified features 211, and outputs the further refined purified features 211.

The diffusion model of the purification engine 206 may be an off-the-shelf diffusion model that is pre-trained or new diffusion model that is trained or fine-tuned using a training dataset or one or more corpora of training audio signals 203a. The diffusion model is fine-tuned to identify the instances of adversarial noise in the input features 205 of the training audio signals 203a and generate predicted purified features 211.

The deepfake detector 210 includes layers of one or more machine-learning models programmed and trained for determining whether an input audio signal 203 is genuine or fraudulent, or otherwise detecting deepfake fraud in the input audio signal 203, using the purified features 211. The deepfake detector 210 ingests the purified features 211 in the form of a feature vector embedding (sometimes called a “fakeprint”) of the purified features 211. The deepfake detector 210 includes a machine-learning model programmed and trained to predict a likelihood that a deepfake occurs in the input audio signals 203 using the fakeprint of the purified features 211. The deepfake detector 210 receives the fakeprint of the purified features 211 for the input audio signal 203 and generates a deepfake score for the input audio signal 203.

An initial layer of the deepfake detector 210 receives the purified features 211 from the purification engine 206. In some cases, the initial layer generates or extracts the fakeprint feature vector embedding using the purified features 211 or clean reconstructed version of the input audio signal 203. The deepfake detector 210 includes a neural network architecture suitable for audio classification tasks, such as a convolutional neural network (CNN) or a recurrent neural network (RNN). Multiple hidden layers process the features, extracting relevant patterns and representations, which generate or output a deepfake score for the input audio signal 203. An output layer or fully connected layer produces a classification result, indicating whether the input audio signal 203 is genuine or fraud containing adversarial deepfake.

As mentioned, the machine-learning architecture 202 may operate in various operational phases, including the training phase, an optional enrollment phase, and the deployment phase (sometimes referred to as “inference time” or “testing”).

At the training phase, the server feeds each training audio signals 203a to the machine-learning architecture 202. For a given training audio signals 203a, the input layers 204 extract and output training input features 205 of the training audio signal 203a, which are then used for training the various downstream machine-learning models of the machine-learning architecture 202.

The diffusion model of the purification engine 206 is trained on the training audio signals 203a to identify adversarial noise or other types of signal distortion of the training audio signals 203a, and then generate purified features 211 by separating genuine audio signal features from the adversarial noise. During training, the diffusion model undergoes supervised learning using the training audio signals 203a and associated training labels. The diffusion model learns to map noisy input features 205 to corresponding clean versions. The training process involves optimizing or adjusting the parameters of the diffusion model using backpropagation and loss to minimize the loss between a predicted clean signal and an expected clean signal.

As an example, for a given training audio signal 203a, the diffusion model identifies adversarial noise occurring in the training input features 205. The diffusion model then mitigates or eliminates the identified adversarial noise in the training input features 205 and reconstructs a predicted clean audio signal for the training audio signals 203a and/or clean features, which the diffusion model outputs as predicted purified features 211 of the training audio signal 203a. The machine-learning architecture 202 includes a loss function that determines a level of error or loss as a measure or value indicating a distance or discrepancy between the predicted purified features 211 or predicted clean audio signal and expected purified features 211 or expected clean audio signal, as indicated by the training labels. The machine-learning architecture 202 may adjust or tune the parameters of the diffusion model to minimize the loss. The server determines that the diffusion model is trained when the loss satisfies a corresponding training threshold value.

In some cases, the server further fine-tunes a trained diffusion model. The diffusion model may be fine-tuned using additional datasets or samples (e.g., enrollment audio signals 203b, inbound audio signals 203c) to improve performance on specific types of noise or audio features. The machine-learning architecture 202 may periodically or continually determine loss and adjust the parameters of the diffusion model to, for example, enhance denoising capabilities or to consider additional features or types of characteristics for identifying noise or adversarial samples. The fine-tuning process involves optimizing or adjusting the parameters of the diffusion model using backpropagation and loss to minimize the loss between a reconstructed clean signal and an actual clean signal or expected audio signal indicated by a training label.

The deepfake detector 210 is trained using the training purified features 211 to determine whether a training audio signal 203a is genuine or fraudulent. The machine-learning architecture 202 feeds the training purified features 211 into the deepfake detector 210 in the form of a feature vector embedding, also known as a “fakeprint.” The machine-learning model of the deepfake detector 210 is programmed and trained to predict the likelihood of a deepfake presence in the training audio signals 203a using this fakeprint. At the training phase, the deepfake detector 210 generates a predicted deepfake score that indicates the probability of the training audio signal 203a being genuine or fraudulent. The deepfake detector 210 determines that the training audio signal 203a is a predicted genuine signal or predicted fraud signal in response to the determining that the predicted deepfake scores satisfies one or more thresholds. The deepfake detector 210 determines a level of error loss based upon a difference or discrepancy between the predicted output(s) (e.g., predicted deepfake score, predicted classification) and expected output(s) (e.g., expected deepfake score, expected classification) indicated by a training label for the training audio signal 203a. Throughout the training process, the server continually optimizes and adjusts the parameters of the deepfake detector using backpropagation and loss minimization to adjust the parameters of the deepfake detector 210. The server determines that the deepfake detector 210 is trained when the loss satisfies a corresponding training threshold value.

At deployment, the server receives an inbound audio signal 203c and executes the machine-learning architecture 202 on the inbound audio signals 203c. The machine-learning architecture 202 feeds the inbound audio signal 203c to the input layers 204 to perform various preprocessing operations on the inbound audio signal 203c, which includes extracting inbound input features 205 of the inbound audio signal 203c.

The machine-learning architecture 202 feeds the input features 205 to the purification engine 206. The diffusion model of the purification engine 206 identifies instances of adversarial noise occurring in the input features 205 and generates inbound purified features 211 that are separated from the adversarial noise identified in the input features 205. In some cases, the purification engine 206 may generate or reconstruct a clean version of the inbound audio signal 203c that does not have the identified adversarial noise. The machine-learning architecture 202 feeds the inbound purified features 211 and/or the clean version of the inbound audio signal 203c to the deepfake detector 210.

The purification engine 206 or the deepfake detector 210 of the machine-learning architecture 202 may generate or extract the inbound fakeprint for the inbound audio signal 203c using the purified features 211 or the clean version of the inbound audio signal 203c.

The deepfake detector 210 generates an inbound deepfake score, using the inbound fakeprint of the inbound audio signal 203c, indicating a likelihood of the inbound audio signal 203c being genuine or fraudulent. Based on the inbound deepfake score, the deepfake detector 210 can determine whether the input audio signal 203 is genuine or fraudulent. For instance, the deepfake detector 210 may determine that the inbound audio signal 203c is a fraudulent signal containing an adversarial deepfake signal noise in response to determining that the inbound deepfake score satisfies a fraud detection threshold.

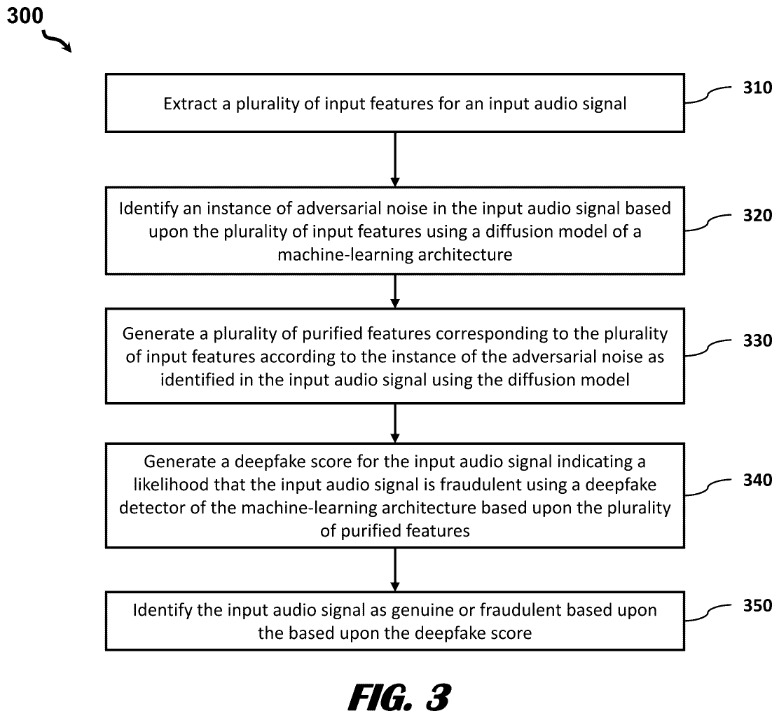

FIG. 3 is a flowchart showing operations of a process 300 for detecting adversarial deepfake attacks audio signal data using a machine-learning architecture, according to an embodiment.

At operation 310, a server (e.g., analytics server 102) extracts a plurality of input features for an input audio signal. The input audio features may be extracted by input layers of the machine-learning architecture, where the input layers are programmed or trained to extract the input features that are indicative of adversarial attacks or other types of deepfake or spoofing fraud in the audio signals.

At operation 320, the server identifies an instance of adversarial noise in the input audio signal based upon the plurality of input features using a diffusion model of a machine-learning architecture that is trained to identify instances of adversarial noise features extracted in audio signals.

At operation 330, the server uses the diffusion model to generate a plurality of purified features corresponding to the plurality of input features based on the identified instance of the adversarial noise in the input features of the input audio signal.

At operation 340, the server uses a deepfake detector of the machine-learning architecture to generate a deepfake score for the input audio signal based upon the plurality of purified features. The deepfake score indicates the likelihood that the input audio signal is fraudulent.

At operation 350, the server identifies the input audio signal as genuine or fraudulent based upon the deepfake score. The server compares the deepfake scores against a fraud detection threshold score. The server identifies the input audio signal as fraudulent in response to determining that the deepfake score satisfies the fraud detection threshold score.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for detecting fraudulent calls based on adversarial noise indicating adversarial attacks, the method comprising:
extracting, by a computer, a plurality of input features for an input audio signal;
identifying, by the computer, an instance of adversarial noise in the input audio signal based upon the plurality of input features using a diffusion model of a machine-learning architecture, the diffusion model trained to identify instances of adversarial noise features extracted in audio signals;
generating, by the computer, a plurality of purified features corresponding to the plurality of input features according to the instance of the adversarial noise as identified in the input audio signal using the diffusion model;
generating, by the computer, a deepfake score for the input audio signal indicating a likelihood that the input audio signal is fraudulent using a deepfake detector of the machine-learning architecture based upon the plurality of purified features; and
identifying, by the computer, the input audio signal as genuine or fraudulent based upon the deepfake score.

2. The method according to claim 1, further comprising:
generating, by the computer, a loss for the diffusion model using a loss function, the loss indicating a distance between the plurality of purified features for the input audio signal and a plurality of expected purified features indicated by a training label associated with the input audio signal; and
updating, by the computer, one or more diffusion parameters of the diffusion model based upon the loss.

3. The method according to claim 1, further comprising:
generating, by the computer, a loss for the deepfake detector using a loss function, the loss indicating a distance between the deepfake score as generated for the input audio signal and an expected deepfake score indicated by a training label associated with the input audio signal; and
updating, by the computer, one or more diffusion parameters of the diffusion model based upon the loss; and
updating, by the computer, one or more detection parameters of the deepfake detector based upon the loss.

4. The method according to claim 1, further comprising:
receiving, by the computer, the input audio signal having the plurality of features; and
executing, by the computer, a transformation function on the input audio signal to convert the input audio signal from a time domain to a transformed domain, wherein the computer extracts the plurality of features from the transformed domain of the input audio signal.

5. The method according to claim 4, wherein the transformed domain includes at least one of a Gaussian space, a frequency domain, or a time-frequency domain.

6. The method according to claim 1, further comprising generating, by the computer, a clean version of the input audio signal based upon the plurality of purified features using a transform function.

7. The method according to claim 1, further comprising extracting, by the computer, a fakeprint feature vector embedding based upon the plurality of purified features, wherein the deepfake detector generates the deepfake score using the fakeprint feature vector embedding.

8. The method according to claim 1, wherein the computer identifies the input audio signal fraudulent in response to determining that the deepfake scores satisfies a fraud detection threshold score.

9. The method according to claim 8, further comprising: generating, by the computer, an alert notification for display at a user interface indicating that the input audio signal has been identified as fraudulent in response to determining that the deepfake score satisfied the fraud detection threshold score.

10. A system for detecting fraudulent calls based on adversarial noise indicating adversarial attacks, the system comprising:
a computer comprising at least one processor, the computer configured to:
extract a plurality of input features for an input audio signal;
identify an instance of adversarial noise in the input audio signal based upon the plurality of input features using a diffusion model of a machine-learning architecture, the diffusion model trained to identify instances of adversarial noise features extracted in audio signals;
generate a plurality of purified features corresponding to the plurality of input features according to the instance of the adversarial noise as identified in the input audio signal using the diffusion model;
generate a deepfake score for the input audio signal indicating a likelihood that the input audio signal is fraudulent using a deepfake detector of the machine-learning architecture based upon the plurality of purified features; and
identify the input audio signal as genuine or fraudulent based upon the deepfake score.

11. The system according to claim 10, wherein the computer is further configured to:
generate a loss for the diffusion model using a loss function, the loss indicating a distance between the plurality of purified features for the input audio signal and a plurality of expected purified features indicated by a training label associated with the input audio signal; and
update one or more diffusion parameters of the diffusion model based upon the loss.

12. The system according to claim 10, wherein the computer is further configured to:
generate a loss for the deepfake detector using a loss function, the loss indicating a distance between the deepfake score as generated for the input audio signal and an expected deepfake score indicated by a training label associated with the input audio signal; and
update one or more diffusion parameters of the diffusion model based upon the loss; and
update one or more detection parameters of the deepfake detector based upon the loss.

13. The system according to claim 10, wherein the computer is further configured to:
receive the input audio signal having the plurality of features; and
execute a transformation function on the input audio signal to convert the input audio signal from a time domain to a transformed domain, wherein the computer extracts the plurality of features from the transformed domain of the input audio signal.

14. The system according to claim 13, wherein the transformed domain includes at least one of a Gaussian space, a frequency domain, or a time-frequency domain.

15. The system according to claim 10, wherein the computer is further configured to generate a clean version of the input audio signal based upon the plurality of purified features using a transform function.

16. The system according to claim 10, wherein the computer is further configured to extract a fakeprint feature vector embedding based upon the plurality of purified features, and wherein the deepfake detector generates the deepfake score using the fakeprint feature vector embedding.

17. The system according to claim 10, wherein the computer identifies the input audio signal fraudulent in response to determining that the deepfake scores satisfies a fraud detection threshold score.

18. The system according to claim 17, wherein the computer is further configured to generate an alert notification for display at a user interface indicating that the input audio signal has been identified as fraudulent in response to determining that the deepfake score satisfied the fraud detection threshold score.

19. A non-transitory computer readable medium configured to stored executable instructions for detecting fraudulent calls based on adversarial noise indicating adversarial attacks that when executed by one or more processors, cause the one or more processor to:
extract a plurality of input features for an input audio signal;
identify an instance of adversarial noise in the input audio signal based upon the plurality of input features using a diffusion model of a machine-learning architecture, the diffusion model trained to identify instances of adversarial noise features extracted in audio signals;
generate a plurality of purified features corresponding to the plurality of input features according to the instance of the adversarial noise as identified in the input audio signal using the diffusion model;
generate a deepfake score for the input audio signal indicating a likelihood that the input audio signal is fraudulent using a deepfake detector of the machine-learning architecture based upon the plurality of purified features; and
identify the input audio signal as genuine or fraudulent based upon the deepfake score.

20. The computer-readable medium of claim 19, wherein the instructions further instruct the one or more processors to:
generate a loss for the deepfake detector using a loss function, the loss indicating a distance between the deepfake score as generated for the input audio signal and an expected deepfake score indicated by a training label associated with the input audio signal; and
update one or more diffusion parameters of the diffusion model based upon the loss; and
update one or more detection parameters of the deepfake detector based upon the loss.
